(19) United States
(12) Patent Application Publication
(10) Pub. No.: US 2007/0078721 A1
(43) Pub. Date: Apr. 5, 2007

(54) Process of auto-renewing limited time software and services agreement

(76) Inventors: Shree A. Dandekar, Round Rock, TX (US); Jeremy Friedlander, Austin, TX (US); James A. Howell JR., Georgetown, TX (US)

Correspondence Address: HAMILTON & TERRILE, LLP, P.O. BOX 203518, AUSTIN, TX, 78720, US

(21) Appl. No.: 11/221,063

(22) Filed: Sep. 7, 2005

(51) Int. Cl. G06Q 30/00

(52) U.S. Cl. 705/26

(57) ABSTRACT

An apparatus for preconfiguring an information handling system which includes means for configuring a system with options selected according to user input wherein the options includes at least one renewable component, means for enabling a customer to indicate authorization to automatically renew the renewable component, and a database that receives information from and supplies information to the configurator and the automatic renewal module is disclosed.

### BACKGROUND OF THE INVENTION

1. Field of the Invention

The present invention relates to build to order systems, and more particularly, pre-configuring a system using after point of sale information.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to order information handling systems either via the telephone or over the internet. It is also known to custom configure systems that are ordered via either method.

One issue relating to information handling systems that are custom configured relates to providing software or services with the custom configured information handling system. The software or services may be provided when software or services are ordered when the information handling system is ordered or via an additional opportunity to order the software or services after the system is received by a customer.

More specifically, when a custom configured information handling system is ordered, a customer is provided with an opportunity to order additional software or some form of a subscription service at the time of ordering the custom configured information handling system. Additionally, the custom configured information handling system is provided to the customer with an additional opportunity to order additional software or some form of subscription service. Certain software or subscription services may have limited time licenses (i.e., the software or subscription services are renewable components of the information handling system).

It is known to provide renewable components with the option of automatic renewal when the components are installed onto an information handling system by the user of the information handling system. However, known processes do not provide an effective method for automatically renewing customers for the software products or services that were ordered via the manufacturer of the information handling system, either at the point of sale or via the provided additional opportunity. Because the manufacturer often receives revenue from the original sale as well as from any renewal it is desirable for the manufacturer to be able to provide the opportunity for the customer to automatically renew the software as well as a mechanism for tracking the renewal.

### SUMMARY OF THE INVENTION

In accordance with the present invention, a process for auto renewing limited term software or service agreements by a manufacturer is described. More specifically, the process includes providing a process that allows customers to automatically renew limited term software or service agreements via a configurator. The configurator provides a selection next to appropriate software and service categories that grants the manufacturer permission to recharge an account such as a credit card account than a predefined term commitment expires. The manufacturer then communicates the renewal to the customer and updates appropriate internal systems and partner systems to reflect the changed status. The system can also include an option for renewal when an original account is no longer valid.

In one embodiment, the invention relates to a system for configuring an information handling system which includes a configurator which configures a system with options selected according to user input wherein the options includes at least one renewable component, an automatic renewal module which enables a customer to indicate authorization to automatically renew the renewable component, and a database that receives information from and supplies information to the configurator and the automatic renewal module.

In another embodiment, the invention relates to an apparatus for preconfiguring an information handling system which includes means for configuring a system with options selected according to user input wherein the options includes at least one renewable component, means for enabling a customer to indicate authorization to automatically renew the renewable component, and a database that receives information from and supplies information to the configurator and the automatic renewal module.

In another embodiment, the invention relates to a method of configuring an information handling system for automatic renewal which includes configuring a system with options selected according to user input wherein the options include at least one renewable component, enabling a user to authorize automatic renewal of the renewable component, presenting payment options and obtaining payment information during a checkout process wherein the payment information is applied to the automatic renewal of the renewable component, and using information derived during configuring for enabling.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of access to a system configuration store.

FIG. 2 shows a system block diagram of an information handling system.

FIG. 3 shows a schematic block diagram of the operation of the system configuration store

FIG. 4 shows a schematic block diagram of the system configuration store.

FIG. 5 shows a flow diagram of the configuration of an information handling system to include the customization features.

FIG. 6 shows a flow diagram of the operation of a system for enabling automatic renewal of software and service agreements.

### DETAILED DESCRIPTION

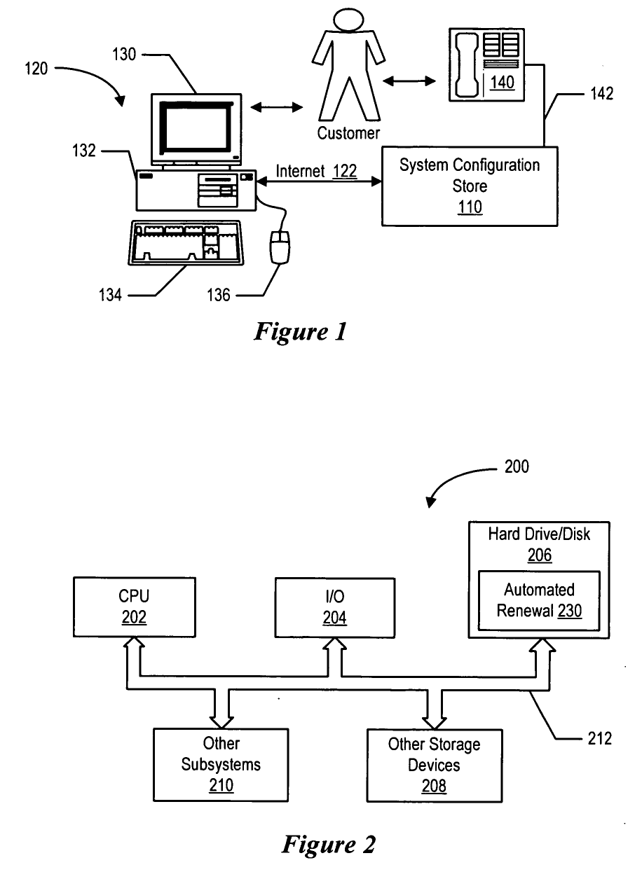

Referring to FIG. 1, a customer can access the system configuration store 110 using any suitable computer equipment 120, via the Internet 122. The computer equipment 120 may include a display 130, computer 132, keyboard 134, and pointing device 136. Display 130 is used for displaying the various pages of the on-line store while a customer is using the on-line store. Alternately, a customer can access the system configuration store 110 via a telephone 140 which is coupled to the system configuration store via a telephone network 142. In the case of a telephone access to the system configuration store, the customer speaks with a sales representative who obtains the configuration information from the customer and in turn enters the information into the system configuration store 110 to configure a system. The system configuration store 110 provides the ability for a customer to enable automatically renewal of limited term software or service agreements by a manufacturer.

Referring to FIG. 2, a system block diagram of an information handling system 200 is shown having features thereof configured in accordance with the system configuration store 110 as discussed herein. The information handling system 200 includes a processor 202, input/output (I/O) devices, such as a display, a keyboard, a mouse, and associated controllers, collectively designed by a reference numeral 204, a non-volatile memory 206 such as a hard disk and drive, and other storage devices, such as a floppy disk and drive and other memory devices 208, and various other subsystems 210, all interconnected via one or more buses 212.

The information handling system 200 also includes an automatic renewal module 230 stored on the non-volatile memory.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

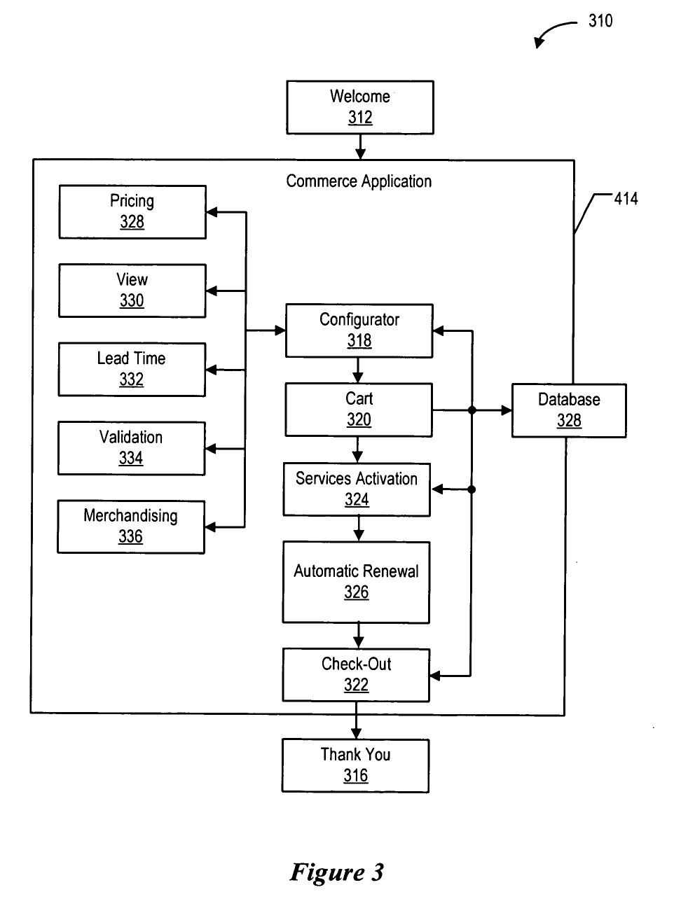

Referring to FIG. 3, an on-line store is a component of an Internet website to which a customer may go to configure a particular information handling system, for example, according to desired options of the customer. An on-line store is one example of a system configuration store 110. The on-line store is typically a subset of a larger Internet website. At the on-line store, a customer can select one or more products in which the customer is interested. Upon selection of a particular product, the on-line store presents the customer with the ability to go to the product information for the particular product, customize the product, price the customized product, purchase the product, and other actions as discussed. While shopping happens in the website (i.e., selection of a particular kind of system by a customer), when the customer is ready to purchase a customized system, the customer is then directed to that part of the website which the on-line store application controls.

An on-line store 310 for use in generating customer configured information handling systems, e.g., customer configured computer systems, is shown. The on-line store 310 includes a welcome or introductory module 312, a commerce application module 314, and a thank you module 316. The on-line store 310 includes an on-line store user interface which enables the system configuration, pricing, and ordering of an information handling system via the Internet. The commerce application 314 includes a configurator 318, shopping cart 320, a checkout module 322, a services activation module 324, an automatic renewal module 326 and database 328. The database 328 provides information to the configurator 318, shopping cart 320, checkout module 322, services activation module 324 and automatic renewal module 326. The configurator 318 includes a pricing module 328, a view module 330, a lead time warning module 332, a validation (or compatibility) warning module 334, and a merchandising module 336. The various modules of the configurator 318 are driven by data from the database 328, and thus the configurator 318, shopping cart 320, checkout module 322 and services activation module 324 are all linked to the database 328.

In operation of the on-line store 310, the welcome module 312 presents a welcome page 312, the configurator 318 presents a configurator page, the shopping cart 320 presents a shopping cart page, the checkout module 322 presents a checkout page, the services activation module 324 presents a services activation page, the automatic renewal module 326 provides a registration and customization page and the thank you module 316 presents a thank you page. The welcome page includes a static page and generally resides outside of the commerce application 314. The configurator page, shopping cart page, checkout page, services activation page and registration and customization page are within the commerce application and use information provided by the database. The checkout includes a payment feature, delivery feature, personal versus business feature, and instructional text features (i.e., how to fill out an on-line form.)

The welcome page is typically an introductory page and includes a link into the on-line store 310. The welcome page is typically a static welcome page. Upon completion of configuration of a system, is transferred to a services activation page in which the customer is provided an opportunity to activate various services such as internet service or content services such as music services. After completion of the services activation, the customer is transferred to the automatic renewal page. After completion of the automatic renewal, the customer is transferred to a checkout page. After completion of the checkout, the customer is transferred to a static thank you page. The thank you page provides a message of gratitude to the customer for having placed the order or for visiting the on-line store.

Aspects of the configurator 318 which interact with database 328 are shown in FIG. 3. In essence, the entire commerce application 314 interacts with the database. The configurator 318, shopping cart 320, checkout module 322, services activation module 324 and registration and customization module are each part of the commerce application 314 and interact with the database 328. For example, with the shopping cart 320, additional merchandising information associated with a particular system which has been configured and placed in the shopping cart by an on-line store customer can be provided.

Also, various services may be provided for order by the customer by the services activation module 324 based upon the type of system ordered as well as components that are included within the system ordered. Additionally, by providing the services activation module 326 and the automatic renewal module 236 within the commerce application 314, the customer continues the experience a similar customer experience and the system provider is able to use the information from the database 328 and to maintain control over the customer contact. By maintaining control over the customer contact the system provider is able to determine what services are activated and to maintain accurate and up to date records of the service activation.

When a purchase is processed via the telephone, then the customer representative interacts with a system similar to configurator 318.

The automatic renewal module 326 allows customers to automatically renew limited term software or service agreements via the commerce application 314. The automatic renewal module 326 may provide a selection (e.g., via selection buttons) next to appropriate software and service categories that grants the manufacturer permission to recharge an account such as a credit card account when a predefined term commitment expires. The manufacturer then communicates the renewal to the customer and updates appropriate internal systems and partner systems to reflect the changed status. The automatic renewal system can also include an option for renewal when an original account is no longer valid.

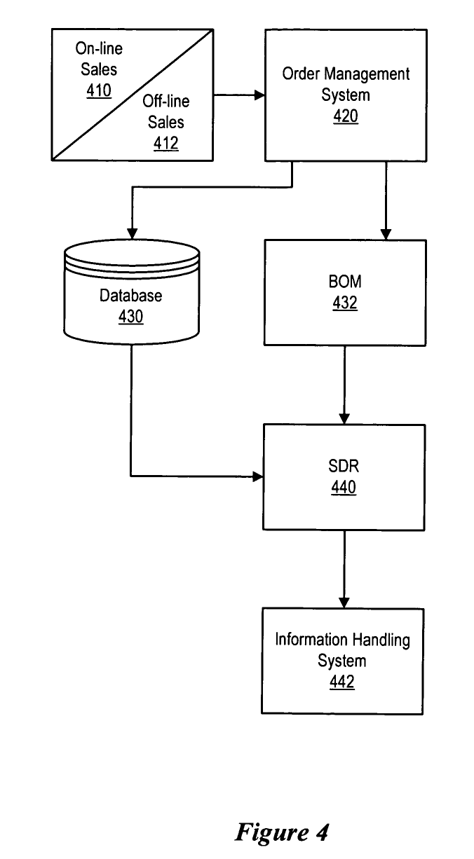

Referring to FIG. 4, when automatic renewal information is obtained either via on-line sales 410 or via off-line (e.g., telephone) sales 412, the information is provided to an order management system 420 which interacts with the factory in which the system is manufactured. The order management system 420 stores this information to a database 430 as well as to a Bill of Materials (BOM) 432 which is associated with a particular system being manufactured. It will be appreciated that one or both the database 430 or the BOM 432 may be used to transfer the information from the customer order to a particular information handling system. The information is then stored in a system descriptor record (SDR) which is stored on the memory of the information handling system 442 being manufactured. Accordingly, the automatic renewal information that is obtained from the customer is stored on the system that is manufactured for that customer.

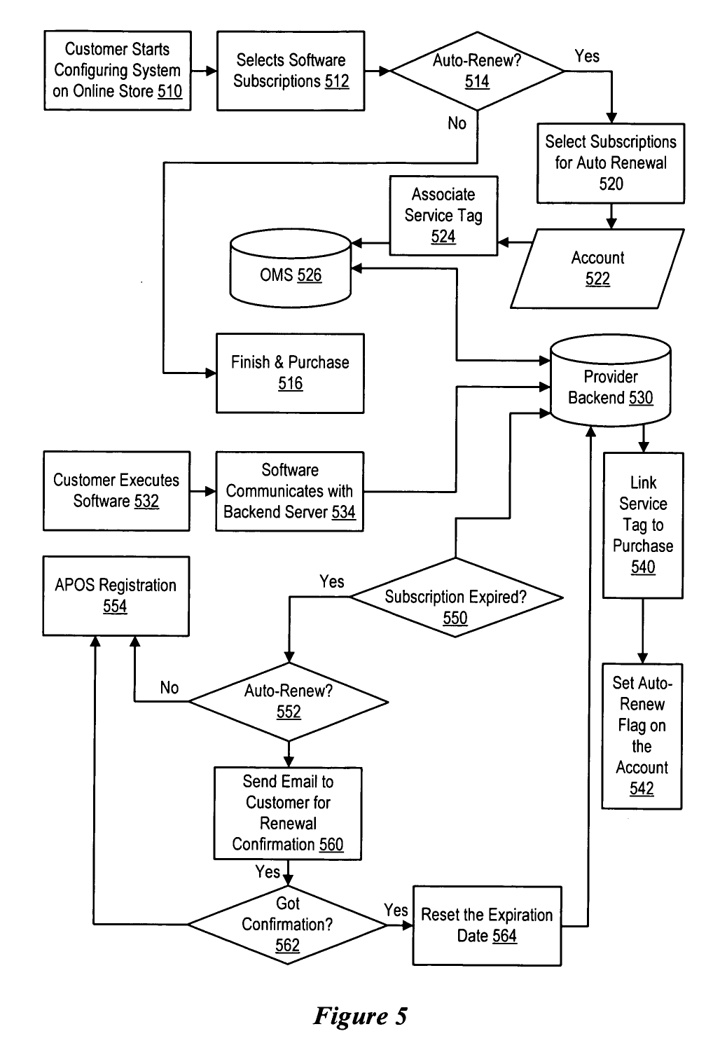

Referring to FIG. 5, a flow diagram of the operation of a system 500 for enabling automatic renewal of software and service agreements is shown. The system 500 includes a manufacturer portion 506 and a customer portion 508. More specifically, the order portion 506 of the system 500 starts when a customer starts configuring an information handling system either via the system configuration store 110 at step 510. Next, the customer selects particular software or service subscriptions at step 512 (e.g., via services activation module 324). The particular software or service subscriptions may be multiple software or service subscriptions from multiple vendors. Next the customer selects whether to automatically renew some or all of the selected software or service subscriptions at step 514. If the customer declines the automatic renewal option then the session completes at step 516 with the customer purchasing the particular information handling system.

If the customer opts to use the automatic renewal feature, then the customer selects which software or service subscriptions to automatically renew at step 520. The customer may opt for automatic renewal for any or all of the software or services that were selected. The customer then enters the relevant account information at step 522. For example, the account information can include a credit card number, name associated with the credit card and expiration date of the credit card. Next at step 524, the automatic renewal system associates a service tag of the information handling system with the automatic renewal information and stores this information to the order management system 524. The information about the automatic renewal is also provided to the appropriate backend provider (i.e., each of the providers of the software or service) at step 530. While the information about the automatic renewal is provided to the backend provider, the payment information is not provided to the backend provider.

When the customer first executes the software at step 532, the software automatically communicates with the backend server at step 534 to start a timer for the determination of the renewal period. The backend server 534 links the service tag of the system to the purchase of the software or service at step 540 and sets an automatic renewal flag on the account for the software or service at step 542.

Upon expiration of the software or service the backend server 534 provides an indication to a monitoring portion of the program that is stored on the customer information handling system. The monitoring portion determines that the software or service has expired at step 550. Next the automatic renewal system determines whether the customer has indicated a desire to automatically renew at step 552. If the customer has not so indicated, then the customer portion of the system 500 transfer control to an after point of sale registration module that initiates an after point of sale renewal of the software at step 554. The after point of sale renewal of the software is linked with the information handling system and is via the manufacturer of the information handling system.

If the customer indicated a desire to automatically renew, then the manufacturer sends an email (or other form of communication) to the customer confirming renewal of the software or service at step 560. When the confirmation is received as determined by step 562, the expiration date for the subscription is reset at step 564 and information regarding the reset expiration date is provided to the backend server. If the confirmation was not received, then the customer is transferred to an after point of sale registration module that initiates an after point of sale renewal.

Other Embodiments

Other embodiments are within the following claims.

For example, it will be appreciated that the order in which the customer is presented with the services activation page, the automatic renewal page and check out page may vary. E.g., the customer may checkout before accessing the services activation page. Alternately, the services activation module and the automatic renewal page may be presented as a combined page.

Also for example, it will be appreciated that the automatic renewal module may be provided as a subset of another module's functions, such as the merchandising module 336. Thus customers can select which software for autorenewal as they are selecting individual software applications or upon checkout after an information handling system has been configured including all software that is to be loaded onto the information handling system.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A system for configuring an information handling system comprising:
a configurator, the configurator configuring a system with options selected according to user input, the options including at least one renewable component;
an automatic renewal module, the automatic renewal module enabling a customer to indicate authorization to automatically renew the at least one renewable component; and,
a database, the database receiving information from and supplying information to the configurator, and the automatic renewal module.

2. The system of claim 1 wherein:
the information relating to automatic renewal is pre-loaded onto the information handling system when the information handling system is fabricated.

3. The system of claim 1 wherein:
the configurator and the automatic renewal module provide a customer with a consistent customer experience.

4. The system of claim 1 further comprising
a service activation module, the service activation module enabling a user to activate services based upon the options selected according to user input, the activated services having an option for automatic renewal.

5. The system of claim 1 wherein:
the renewable component is a software application.

6. The system of claim 1 wherein:
the renewable component is a subscription service.

7. An apparatus for preconfiguring an information handling system comprising:
means for configuring a system with options selected according to user input, the options including at least one renewable component;
means for enabling a customer to indicate authorization to automatically renew the at least one renewable component; and,
a database, the database receiving information from and supplying information to the configurator, and the automatic renewal module.

8. The apparatus of claim 7 wherein:
the information relating to automatic renewal is pre-loaded onto the information handling system when the information handling system is fabricated.

9. The apparatus of claim 7 wherein:
the means for configuring and the means for enabling provide a customer with a consistent customer experience.

10. The apparatus of claim 7 further comprising
means for enabling a user to activate services based upon the options selected according to user input, the activated services having an option for automatic renewal.

11. The apparatus of claim 7 wherein:
the renewable component is a software application.

12. The apparatus of claim 7 wherein:
the renewable component is a subscription service.

13. A method of configuring an information handling system for automatic renewal comprising:
configuring a system with options selected according to user input, the options including at least one renewable component;
enabling a user to authorize automatic renewal of the renewable component;
presenting payment options and obtaining payment information during a checkout process, the payment information being applied to the automatic renewal of the renewable component; and,
using information derived during the configuring for the enabling.

14. The method of claim 13 wherein:
information relating to automatic renewal is pre-loaded onto the information handling system when the information handling system is fabricated.

15. The method of claim 13 wherein:
the configuring and the enabling provide a customer with a consistent customer experience.

16. The method of claim 13 further comprising
enabling a user to activate services based upon the options selected according to user input, the activated services having an option for automatic renewal.

17. The method of claim 13 wherein:
the renewable component is a software application.

18. The method of claim 13 wherein:
the renewable component is a subscription service.
